(19) United States
(12) Patent Application Publication
(10) Pub. No.: US 2014/0111832 A1
(43) Pub. Date: Apr. 24, 2014

(54) IMAGE FORMING APPARATUS, IMAGE FORMING METHOD, COMPUTER PROGRAM PRODUCT, AND RECORDING MEDIUM

(71) Applicant: Koji HAYASHI, Kanagawa (JP)

(72) Inventor: Koji HAYASHI, Kanagawa (JP)

(73) Assignee: RICOH COMPANY, LIMITED, Tokyo (JP)

(21) Appl. No.: 14/047,114

(22) Filed: Oct. 7, 2013

(30) Foreign Application Priority Data
Oct. 19, 2012 (JP) 2012-231688

(51) Int. Cl. H04N 1/405

(52) U.S. Cl. CPC H04N 1/40018
USPC 358/3.06

(57) ABSTRACT

An image forming apparatus includes: a first correcting unit that reads a gradation pattern output onto a predetermined medium and corrects a gradation conversion information; a second correcting unit that reads a gradation pattern formed on an image carrier included in the image forming apparatus and corrects a gradation conversion information; a detecting unit that detects a gradation characteristic of the gradation pattern formed on the image carrier at the time of execution of correction by the second correcting unit; and a determining unit that determines whether to execute correction by the first correcting unit on the basis of the detected gradation characteristic.

### CROSS-REFERENCE TO RELATED APPLICATIONS

The present application claims priority to and incorporates by reference the entire contents of Japanese Patent Application No. 2012-231688 filed in Japan on Oct. 19, 2012.

### BACKGROUND OF THE INVENTION

1. Field of the Invention

The present invention relates to an image forming apparatus, image forming method, computer program product, and recording medium.

2. Description of the Related Art

To adjust and maintain the image density to appropriate density, conventional color copiers use a first calibration (ACC) technique for reading a gradation pattern (an ACC pattern) output onto transfer paper with a scanner and correcting a gamma conversion table in combination with a second calibration (IBACC) technique for reading a gradation pattern (an IBACC pattern) formed on an image carrier (an intermediate transfer belt) with an optical sensor opposed to the image carrier and correcting a gamma conversion table according to a read value of the optical sensor (see, for example, Japanese Patent No. 3441994).

However, the above-described first calibration (ACC) technique requires human hand to cause the scanner to read the gradation pattern output onto the transfer paper, and also consumes the transfer paper, so that burdens of time and expense may be imposed on a user; therefore, the first calibration (ACC) technique may not be implemented even though it is a necessary process to obtain a good image (a first problem). The second calibration (IBACC) technique is superior in terms of no such burdens on the user. However, in terms of the performance of detection of a toner adhesion amount (image density) especially in an area having low reflected light quantity (if a toner adhesion amount is high, an area having high image density) due to various constraints for use in a machine (such as a constraint on an amount of light that the optical sensor can use), the second calibration (IBACC) technique is inferior to the scanner (a second problem).

To cope with the second problem, an appropriate density correction is performed by the second calibration (IBACC) to maintain the image density. However, there is a problem that the first calibration (ACC) is also performed even if there is no need to perform the first calibration.

Therefore, it is desirable to provide an image forming apparatus, image forming method, computer program product, and recording medium for detecting appropriate timing to execute auto color calibration (ACC) using a scanner and informing a user of an instruction to execute the ACC.

### SUMMARY OF THE INVENTION

It is an object of the present invention to at least partially solve the problems in the conventional technology.

According to an aspect of the present invention, there is provided an image forming apparatus including: a first correcting unit that reads a gradation pattern output onto a predetermined medium and corrects a gradation conversion information; a second correcting unit that reads a gradation pattern formed on an image carrier included in the image forming apparatus and corrects a gradation conversion information; a detecting unit that detects a gradation characteristic of the gradation pattern formed on the image carrier at the time of execution of correction by the second correcting unit; and a determining unit that determines whether to execute correction by the first correcting unit on the basis of the detected gradation characteristic.

According to another aspect of the present invention, there is provided an image forming method performed by an image forming apparatus, the method including: a first correcting step of reading a gradation pattern output onto a predetermined medium and correcting a gradation conversion information; a second correcting step of reading a gradation pattern formed on an image carrier included in an image forming apparatus and correcting a gradation conversion information; a detecting step of detecting a gradation characteristic of the gradation pattern formed on the image carrier at the time of execution of the second correcting step; and a determining step of determining whether to execute the first correcting step on the basis of the detected gradation characteristic.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 shows a configuration of an entire copier;

FIG. 2 shows a control system built in the copier;

FIG. 3 shows a configuration of an image forming apparatus according to the present invention;

FIG. 4 is a diagram for explaining a gradation-conversion-table correcting process according to the present invention;

FIG. 5 is a flowchart of a procedure for acquiring a gradation correction gamma characteristic shown in FIG. 4;

FIG. 6 is a flowchart of an auto color calibration process;

FIGS. 7A-7C are a diagram for explaining the auto color calibration;

FIG. 8 is a diagram for explaining a gradation pattern formed on an image carrier;

FIG. 9 is a diagram for explaining how to determine whether the execution of the auto color calibration is necessary or not;

FIG. 10 shows a screen of an operation unit that displays thereon a recommendation on the execution of the auto color calibration;

FIG. 11 is a flowchart of an IBACC-reference-value updating process; and

FIG. 12 is a diagram for explaining the IBACC-reference-value updating process.

### DETAILED DESCRIPTION OF THE PREFERRED EMBODIMENTS

Exemplary embodiments of the present invention will be explained in detail below with reference to accompanying drawings. In the present invention, timing to execute auto color calibration is determined in consideration of changes in gradation characteristics of an image forming apparatus (an inclination of toner adhesion amount 7).

### Embodiment

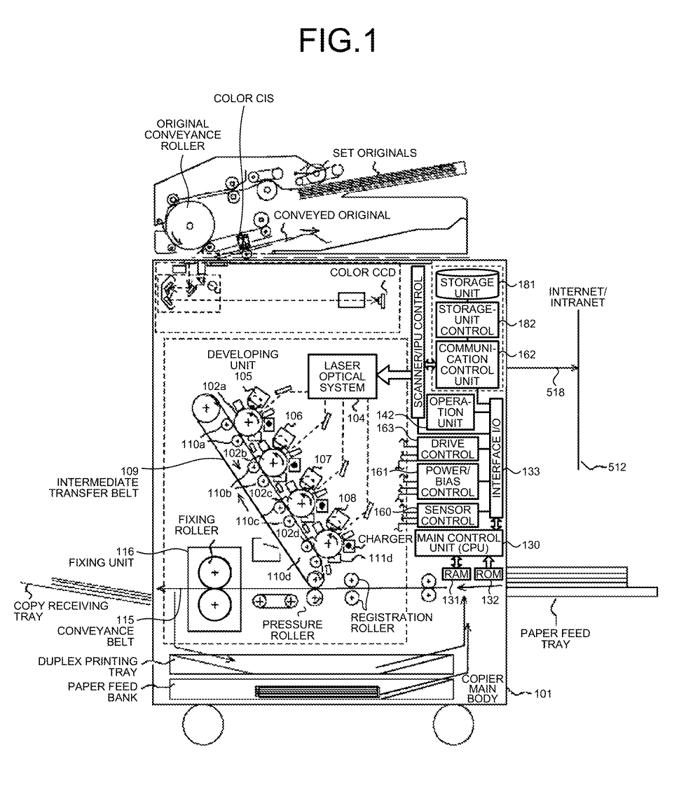

FIG. 1 shows a configuration of an entire copier. In FIG. 1, four organic photoconductor (OPC) drums 102a to 102d with a diameter of 30 [mm] are provided as image carriers to be placed side by side in the central part of a copier main body 101, and chargers 103a to 103d that charge the surfaces of the photoconductor drums 102a to 102d respectively, laser optical systems 104a to 104d that expose the uniformly-charged surfaces of the photoconductor drums 102a to 102d to semiconductor laser beams thereby forming electrostatic latent images on the surfaces of the photoconductor drums 102a to 102d respectively, black (K) developing unit 105, yellow (Y) developing unit 106, magenta (M) developing unit 107, and cyan (C) developing unit 108 that develop the electrostatic latent images into K, Y, M, and C toner images by supplying K, Y, M, and C toners to the electrostatic latent images respectively, an intermediate transfer belt 109 onto which the toner images formed on the photoconductor drums 102a to 102d are sequentially transferred in a superimposed manner, bias rollers 110a to 110d that each apply a transfer voltage to the intermediate transfer belt 109, cleaning units 111a to 111d that remove residual toners remaining on the surfaces of the photoconductor drums 102a to 102d after the transfer of the toner images onto the intermediate transfer belt 109 respectively, and static eliminators 112a to 112d that remove electric charges remaining on the surfaces of the photoconductor drums 102a to 102d after the transfer of the toner images onto the intermediate transfer belt 109 respectively, etc. are sequentially arranged around the photoconductor drums 102a to 102d.

Furthermore, a transfer bias roller 113 for applying a voltage to transfer the transferred toner image to a transfer material and a belt cleaning unit 114 for cleaning the residual toner image after the transfer of the toner image onto the transfer material are installed on the intermediate transfer belt 109.

A fixing unit 116, which applies heat and pressure to the transfer material to fix the toner image on the transfer material, is placed at exit-side end of a conveyance belt 115 for conveying the transfer material separated from the intermediate transfer belt 109, and a copy receiving tray 117 is installed at the exit of the fixing unit 116.

Above the laser optical system 104, a platen glass 118 as an original glass plate placed on top of the copier main body 101, an exposure lamp 119 for emitting a scanning light to an original set on the platen glass 118, a reflection mirror 121, an imaging lens 122, and a CCD image sensor array 123 are installed; the reflection mirror 121 brings a reflected light from the original to the imaging lens 122, and the imaging lens 122 causes the light to enter the CCD image sensor array 123 which is a photoelectric conversion element. An image signal converted into an electrical signal by the CCD image sensor array 123 passes through an image processing apparatus (not shown), and controls laser oscillation of a semiconductor laser included in the laser optical system 104.

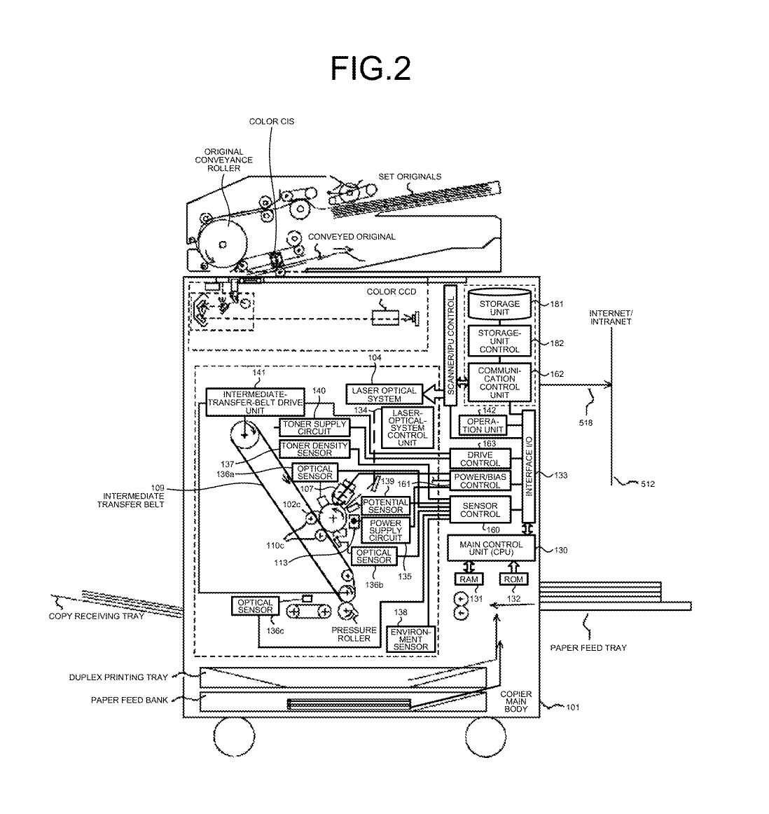

Subsequently, a control system built into the copier is explained. As shown in FIG. 2, the control system includes a main control unit (CPU) 130, and a RAM 131 and a ROM 132 are attached to the main control unit 130. A laser-optical-system control unit 134, a power supply circuit 135, respective optical sensors 136 installed in Y, M, C, and K image forming units, respective toner density sensors 137 installed in the Y, M, C, and K developing units, an environment sensor 138, photoconductor surface potential sensors 139a to 139d, a toner supply circuit 140, an intermediate-transfer-belt drive unit 141, and an operation unit 142 are connected to the main control unit 130 via an interface I/O 133.

The laser-optical-system control unit 134 adjusts the laser output of the laser optical systems 104a to 104d. The power supply circuit 135 provides a predetermined discharge voltage for charging to the chargers 103a to 103d, and provides a predetermined developing bias voltage to the developing units 105, 106, 107, and 108, and provides a predetermined transfer voltage to the bias rollers 110a to 110d and the transfer bias rollers 113a to 113d.

Incidentally, the optical sensors 136 include optical sensors 136a that are opposed to the photoconductor drums 102a to 102d and detect an amount of toner adhered to the photoconductor drums 102a to 102d, optical sensors 136b that are opposed to the intermediate transfer belt 109 and detect an amount of toner adhered to the intermediate transfer belt 109, and optical sensors 136c that are opposed to the conveyance belt and detect an amount of toner adhered to the conveyance belt. Incidentally, practically, it is only necessary for any one of the optical sensors 136a to 136c to detect a toner adhesion amount.

The optical sensor 136 (136a to 136c) is composed of a light-emitting element, such as a light-emitting diode, and a light receiving element, such as a photosensor, which are placed near a post-transfer area of the photoconductor drum 102 (120a to 102d), and is configured to detect a toner adhesion amount in a toner image of a detection pattern latent image formed on the photoconductor drum 102 and a toner adhesion amount in a background part of an image and also detect a so-called residual potential after the static elimination of the photoconductor drum.

A detection output signal from this optical sensor 136 (136a to 136c) is applied to a optical-sensor control unit (not shown). The optical-sensor control unit calculates a ratio of the toner adhesion amount in the detection pattern toner image to the toner adhesion amount in the background part, and detects a fluctuation in image density by comparing a value of the ratio with a reference value, and corrects a control value of each of the respective toner density sensors 137 for Y, M, C, and K colors.

The toner density sensors 137 detect density of toner on the basis of a change in permeability of developer present in the developing units 105 to 108. The toner density sensor 137 has a function of comparing a detected toner density with a reference value and, if the toner density is below a fixed value, i.e., the developing unit has a shortage of toner, applying a toner supply signal according to the shortage to the toner supply circuit 140.

The potential sensors 139 detect respective surface potentials of the photoconductor drums 102a to 102d which are image carriers. The intermediate-transfer-belt drive unit 141 controls the activation of the intermediate transfer belt 109.

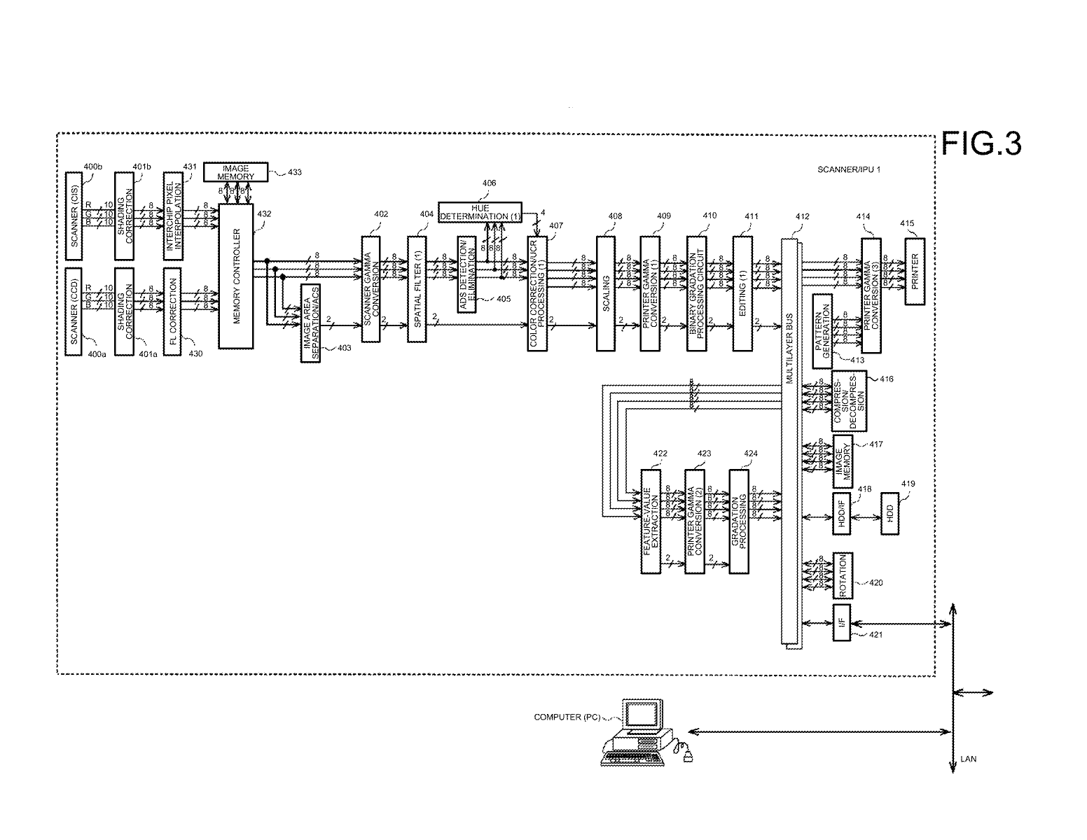

FIG. 3 shows a configuration of an image forming apparatus according to the present invention. In FIG. 3, 400a denotes a scanner using a CCD as a reading device; 400b denotes a scanner using a contact image sensor (CIS) as a reading device; 401a denotes a shading correction circuit for the scanner (CCD) 400a; 401b denotes a shading correction circuit for the scanner (CIS) 400b; 430 denotes an FL correction circuit for the scanner (CCD) 400a; 431 denotes an interchip pixel interpolation circuit for the scanner (CIS) 400b; 432 denotes a memory controller; 433 denotes an image memory; 402 denotes a scanner gamma conversion circuit; 403 denotes an image area separation/ACS determination circuit; 404 denotes a spatial filter; 405 denotes an automatic density adjustment level detection/elimination circuit; 406 denotes a hue determination circuit; 407 denotes a color correction/UCR processing circuit; 408 denotes a scaling circuit; 409 denotes a printer gamma conversion (1) circuit 1; 410 denotes a binary gradation processing circuit; 411 denotes an editing circuit; 412 denotes a multilayer bus; 413 denotes a pattern generation circuit; 414 denotes a printer gamma conversion (3) circuit 3; 415 denotes a printer; 422 denotes a feature-value extraction circuit; 423 denotes a printer gamma conversion (2) circuit 2; 424 denotes a gradation processing circuit; 416 denotes a compression/decompression processing circuit; 417 denotes an image memory; 418 denotes an HDD I/F; 419 denotes an HDD; 420 denotes a rotation processing circuit; 421 denotes an external I/F.

When a user specifies double-side simultaneous scanning, both sides of an original to be copied are simultaneously scanned by the color scanner (CCD) 400a and the color scanner (CIS) 400b during one-time conveyance of the original in such a manner that the color scanner (CCD) 400a reads an image of one side of the original as the front side by separating the image data into, for example, 10-bit R, G, and B color signals, and the color scanner (CIS) 400b reads an image of the other side of the original as the reverse side.

The image signal read by the scanner (CCD) 400a is subjected to shading correction in the main scanning direction by the shading correction circuit 401a, and the corrected image signal is output as an 8-bit signal. Likewise, the image signal read by the scanner (CIS) 400b is subjected to shading correction in the main scanning direction by the shading correction circuit 401b, and the corrected image signal is output as an 8-bit signal. The FL correction circuit 430 corrects a difference in sensitivity (a difference in tone) between two pairs of CCDs arranged in the main scanning direction. The interchip pixel interpolation circuit 431 interpolates image data of a gap between chips of a CIS device arranged in the main scanning direction on the basis of neighboring pixels.

The memory controller 432 is a DDR memory controller for temporarily storing image data 1, which has been read by the scanner (CCD) 400a and processed by the shading correction circuit 401a and the FL correction circuit 430, or image data 2, which has been read by the scanner (CIS) 400b and processed by the shading correction circuit 401b and the interchip pixel interpolation circuit 431, in the image memory 433 using a DDR memory.

The image area separation/ACS determination circuit 403 outputs a determination result (a signal X) of image area separation, such as a text area or a photograph area, with respect to each pixel of the image data 1 and the image data 2 and a color determination result of whether an original is a color original or a black-and-white original.

The scanner gamma conversion circuit 402 converts a read signal from a scanner into reflectivity data or lightness data. The image memory 433 stores therein an image signal of image data subjected to the scanner gamma conversion. The image area separation/ACS determination circuit 403 determines a text part and a photograph part, and also determines whether color is chromatic color or achromatic color.

The spatial filter 404 performs edge enhancement according to the degree of edge of an image signal (adaptive edge enhancement) in addition to a process of changing frequency characteristics of the image signal, such as edge enhancement and smoothing to sharpen or soften an image according to user's predilection. For example, the spatial filter 404 performs so-called adaptive edge enhancement, i.e., performs edge enhancement on edges of characters in a text but does not perform edge enhancement on a halftone image with respect to each of the R, G, and B signals.

The color correction/UCR processing circuit 407 performs a color correction. The color correction/UCR processing circuit 407 is composed of a color correction processing unit and a UCR processing unit. The color correction processing unit compensates a difference between color separation characteristics of an input system and spectral characteristics of color materials of an output system, and calculates respective amounts of Y, M, and C color materials required for accurate color reproduction. The UCR processing unit replaces a YMC overlapped part with black (Bk).

The calculation of the UCR processing is performed by using the following equations.

Y′=Y−α·min(Y,M,C)

M′=M−α·min(Y,M,C)

C′=C−α·min(Y,M,C)

Bk=α·min(Y,M,C)

In the above equations, a denotes a coefficient for determining an amount of UCR; if α=1, 100% UCR processing is performed. Incidentally, a can be a fixed value. An image of a highlight part can be smoothed by setting a value of α, for example, to be close to 1 in a high-density part and be close to 0 in the highlight part (a low image density part).

A color correction coefficient used in color correction differs among fourteen hues: twelve hues that six hues RGBYMC are each divided by two, and black and white. The hue determination circuit 406 determines which hue the read image data corresponds to, and selects a color correction coefficient of each hue on the basis of a result of the determination.

The scaling circuit 408 scales an image in the main-scanning and sub-scanning directions. The printer gamma conversion (1) circuit 409 performs a printer gamma conversion for a text or a printer gamma conversion for a photograph according to an image area separation signal, or performs a printer gamma conversion before the binary gradation processing circuit 410 performs binarization. The binary gradation processing circuit 410 performs binarization, such as simple binarization, binary dithering, binary error diffusion, and binary variable threshold error diffusion, according to any one of text mode, photograph mode, and text/photograph mode specified by a PC via a LAN connected to the operation unit or the I/F 421 at the time of fax transmission or scanner delivery.

The editing circuit 411 performs an editing process, such as border-part masking and logic inversion, on image data. When the image data is stored, the compression/decompression processing circuit 416 compresses the image data received through the multilayer bus 412 and stores the compressed image data in the HDD 419 via the HDD I/F 418. The stored image data is stored as an RGB signal, a K (Gray) signal, a CMYK signal, and an RGBX signal (an X signal is a result of image area separation) depending on the purposes of use. The RGB signal is stored for the purpose of delivery of the image data; the K (Gray) signal is stored for the purpose of delivery or fax transmission of the image data; the CMYK signal is stored for the purpose of printing of the image data on paper; the RGBX signal is stored for the purpose of generation of CMYK data or reprocessing of the image data, such as color space conversion into an sRGB signal to deliver the image data.

In the case of using the image data read by the scanner 400 for fax transmission or scanner transmission, the color correction/UCR processing circuit 407 converts the image data into an s-RGB or K (Gray) signal, and the converted signal is delivered via the I/F 421.

In the case of printing the image data on transfer paper, the color correction/UCR processing circuit 407 converts the image data into CMYK data and outputs the converted image data to the feature-value extraction circuit 422 via the multilayer bus 412, and the feature-value extraction circuit 422 determines the edge, non-edge, and weak edge intermediate between edge and non-edge, etc. of the image. The printer gamma conversion (2) circuit 423 performs a printer gamma conversion on the image data depending on a result of the determination of the edge, non-edge, and weak edge, etc., and the gradation processing circuit 424 performs gradation processing, such as binary or multi-valued dithering, binary or multi-valued error diffusion, and binary or multi-valued variable threshold error diffusion, on the image data.

In the dithering, arbitrary size of dithering can be selected from a range between 1×1 no dithering and dithering with m×n pixels (m and n are positive integers). Here, dithering with, for example, up to 36 pixels can be performed. The size of a dither matrix in dithering with all 36 pixels includes, for example, total 36 pixels of 6 pixels in the main scanning direction times 6 pixels in the sub-scanning direction and total 36 pixels of 18 pixels in the main scanning direction times 2 pixels in the sub-scanning direction.

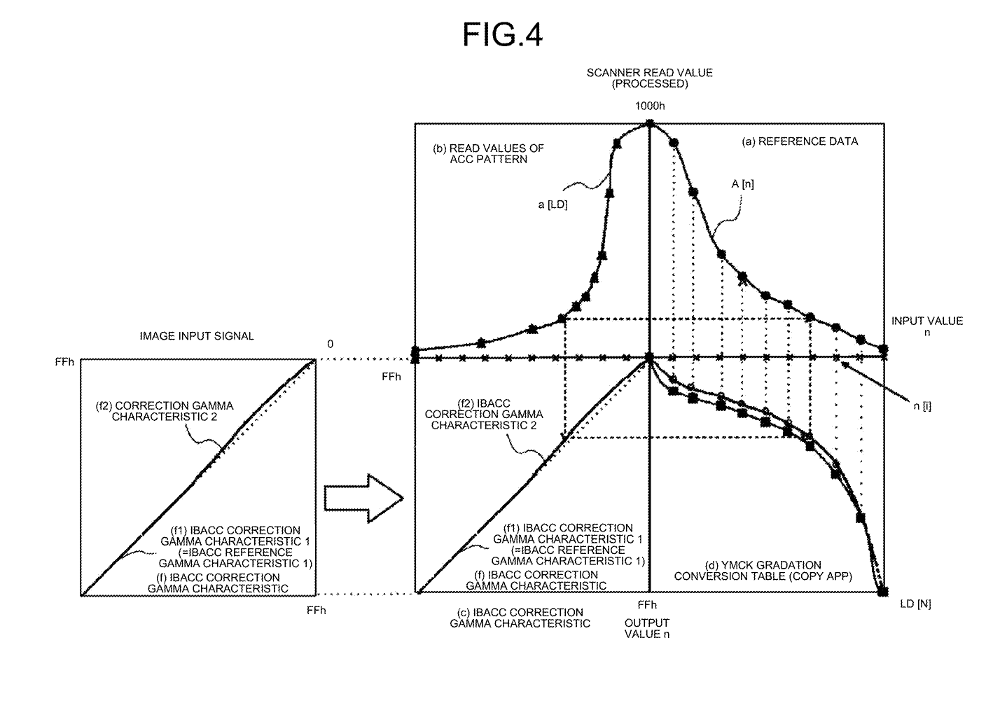

FIG. 4 is a diagram for explaining a gradation-conversion-table (a gradation conversation information) correcting process according to the present invention. A graph in a first phenomenon (a) in FIG. 4 shows reference data A[i], where the horizontal axis indicates an input value n input to a YMCK gradation conversion table, and the vertical axis indicates a scanner read value (processed). The scanner read value (processed) is a value obtained by averaging values of data at several points in a gradation pattern read by the scanner and adding the averaged values, and is processed as a 12-bit data signal for the improvement in calculation accuracy.

A graph in a second phenomenon (b) shows a read value of an ACC pattern, where the horizontal axis indicates a laser (LD) write value and the vertical axis indicates a scanner read value (processed). This data a[LD] represents a printer characteristic. Furthermore, LD write values of an actually-formed gradation are values at 16 points 00h (background), 11h, 22h, . . . , EEh, and FFh, which are discontinuous values; however, here, a continuous graph is drawn by interpolation between detection points.

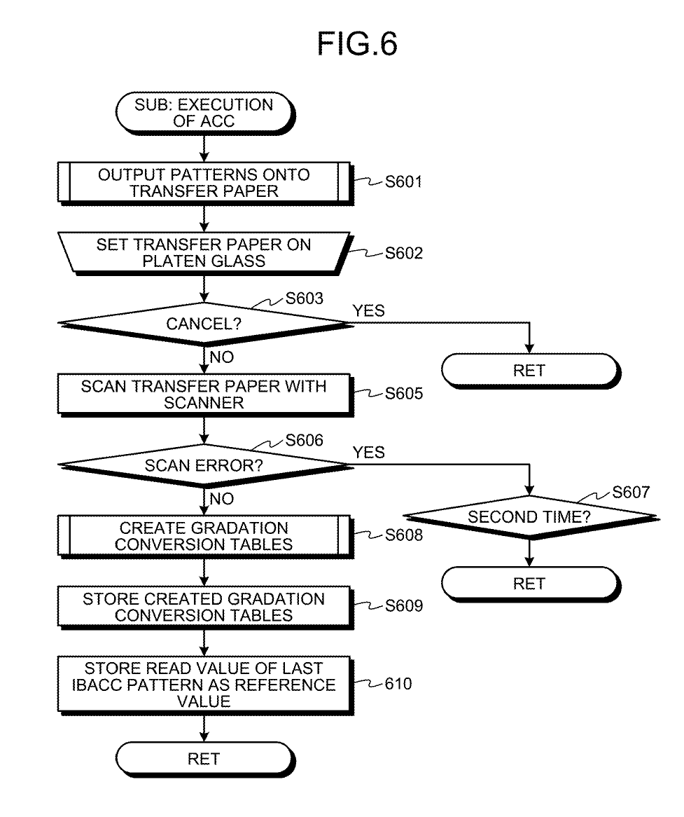

A graph (f) in a third phenomenon shows an IBACC correction gamma characteristic acquired through the flow shown in FIG. 6 to be described later, where the vertical axis indicates an LD write value. An IBACC correction gamma characteristic 1 shown by a graph (f1) is an example of a linear table, and is used as an IBACC reference gamma characteristic 1 used in the execution of ACC. An IBACC correction gamma characteristic 2 shown by a graph (f2) is an example of the IBACC correction gamma characteristic acquired through the flow shown in FIG. 6 to be described later.

A graph (d) in a fourth phenomenon shows a YMCK gradation conversion table LD[i] which is acquired through a process according to the present invention.

The horizontal axis of the graph (d) is the same as in the third phenomenon (c), and the graph shows expedient linear transformation for representing a relationship between an LD write value at the creation of a gradation pattern and a scanner read value (processed) of the gradation pattern. Reference data A[n] with respect to an input value n is obtained, and an LD output LD[n] for obtaining A[n] is calculated by using a read value a[LD] of the gradation pattern along an arrow shown in FIG. 4.

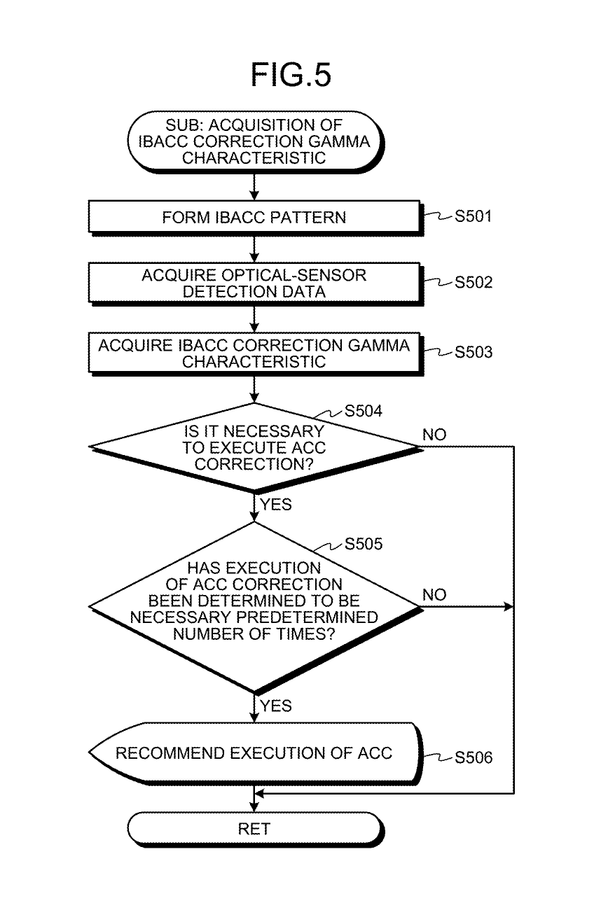

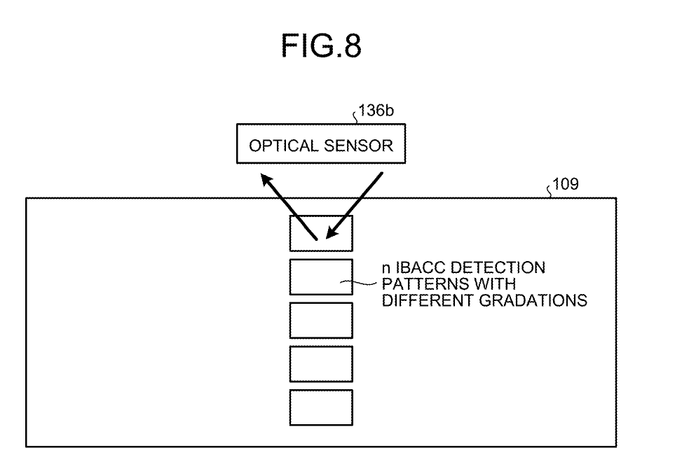

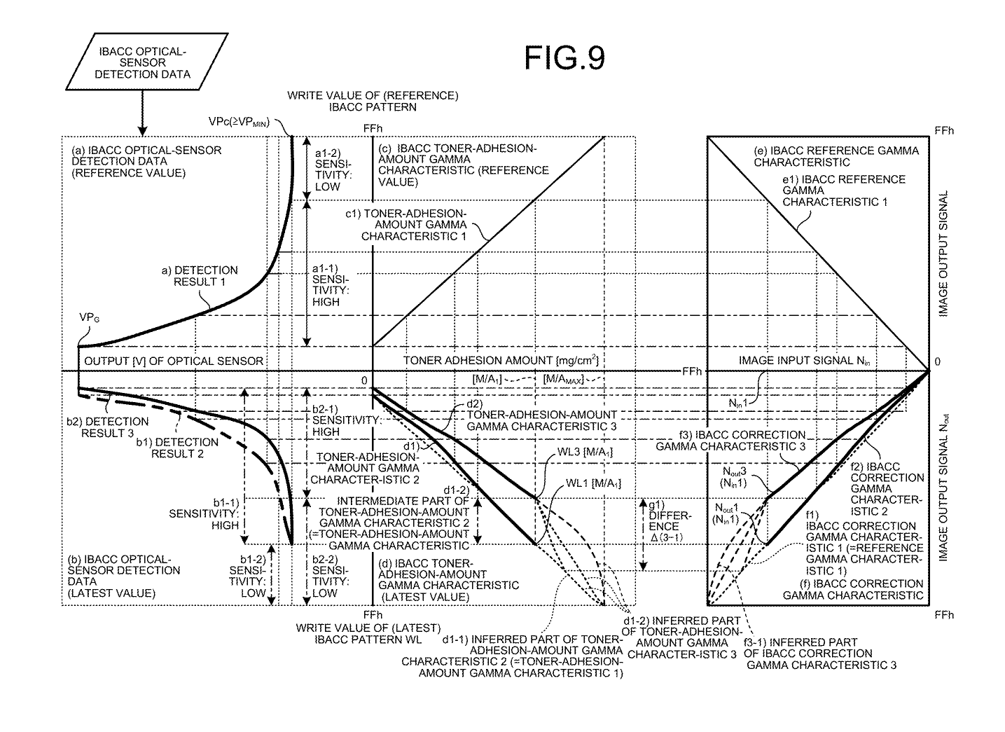

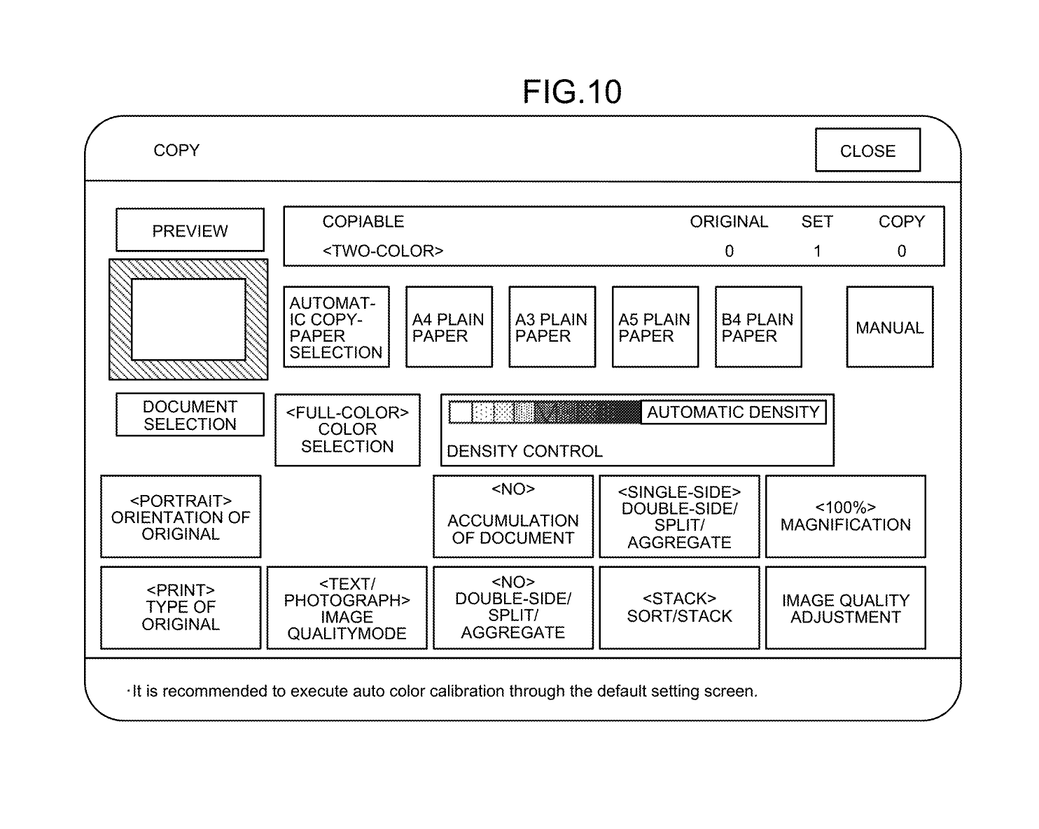

FIG. 5 is a flowchart of a procedure for acquiring an IBACC correction gamma characteristic shown in FIG. 4. At Step S501, the main control unit 130 forms an IBACC pattern (a reference pattern). At Step S502, when the optical sensor has detected the IBACC pattern (the reference pattern), the main control unit 130 acquires optical-sensor detection data. At Step S503, the main control unit 130 acquires an IBACC correction gamma characteristic from the optical-sensor detection data of the IBACC pattern. At Step S504, the main control unit 130 determines whether it is necessary to execute the ACC correction. At Step S505, the main control unit 130 determines whether the number of determinations to execute the ACC correction has reached a predetermined number. When the number of determinations has reached a predetermined number, at Step S506, the main control unit 130 displays information to instruct a user to execute the ACC correction on the screen of the operation unit. Incidentally, details of the processes at Steps S501 and S502 will be described in FIG. 8, details of the processes at Steps S503 and S504 will be described in FIG. 9, and details of the process at Step S506 will be described in FIG. 10.

The above-described process is performed each time images are formed on a predetermined number of sheets (such as 10 to 100 sheets) of transfer paper. Furthermore, in the case of an image processing apparatus including a temperature and humidity sensor capable of detecting the humidity and temperature inside of the apparatus, the above-described process is performed when changes in temperature and humidity has exceeded a predetermined amount of change.

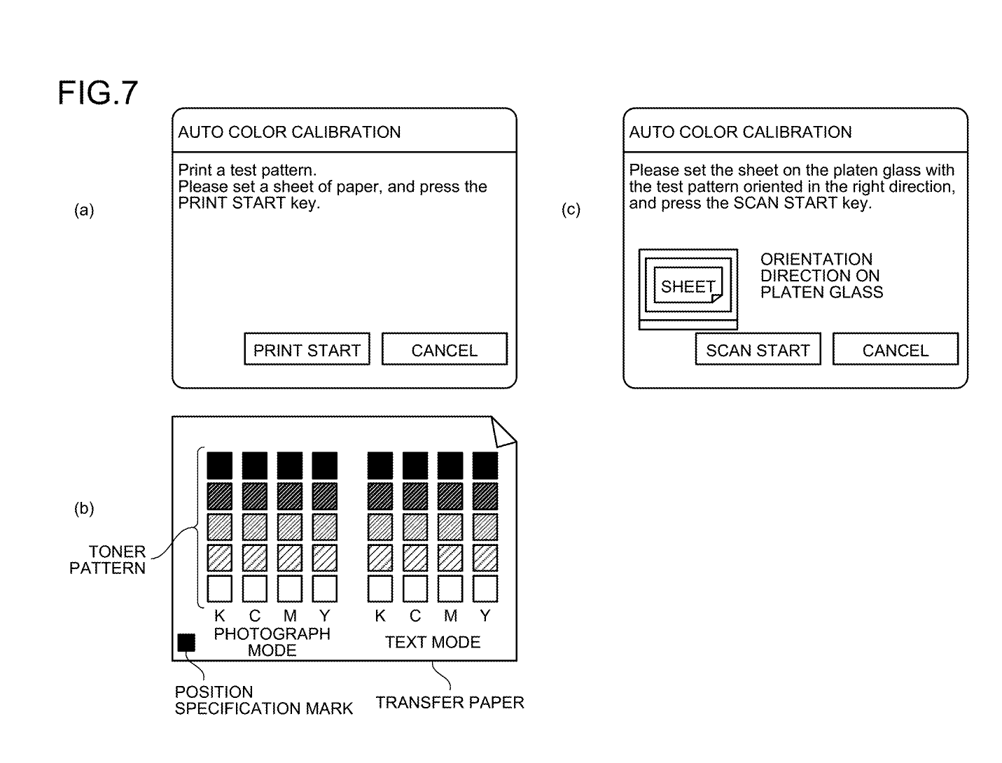

An operation screen for selecting a function of auto color calibration (ACC) of image density (tone) is explained. FIG. 6 is a flowchart of an ACC process. This process is performed by the main control unit 130. When a user selects execution of ACC while the printer is in use, a screen shown in FIG. 7A is displayed.

Then, when the user presses the print start key on the screen shown in FIG. 7A, multiple density gradation patterns corresponding to YMCK colors and image quality modes of text and photograph as shown in FIG. 7B are formed on a transfer material (Step S601). These density gradation patterns have been stored and set in a ROM of an IPU in advance. A pattern write value is displayed in hex notation, and there are 16 patterns: 00h, 11h, 22h, . . . , EEh, and FFh. In FIGS. 7A-7C, five tones of color patches excluding a background part are displayed; however, any values out of the 00h to FFh 8-bit signals can be selected. In text mode, a pattern is formed with 256 tones per dot without performing dithering such as pattern processing; on the other hand, in photograph mode, dithering is performed.

After the patterns have been output onto the transfer material, a screen shown in FIG. 7C is displayed on the operation screen to instruct the user to set the transfer material on the platen glass. In accordance with the instruction on the screen, the user sets the transfer material with the patterns formed thereon on the platen glass (Step S602), and selects either “start reading” or “cancel” on the screen shown in FIG. 7C (Step S603). When “cancel” was selected, the process is terminated (Step S604); on the other hand, when “start reading” was selected, the scanner starts running and reads RGB data of the YMCK density patterns (Step S605). At this time, the scanner reads both data of a pattern part and data of a background part.

The main control unit 130 determines whether data of the pattern part has been read properly (Step S606). When data of the pattern part has not been read properly, the screen shown in FIG. 7C is again displayed. When data of the pattern part was not properly read twice, the process is terminated (Step S607).

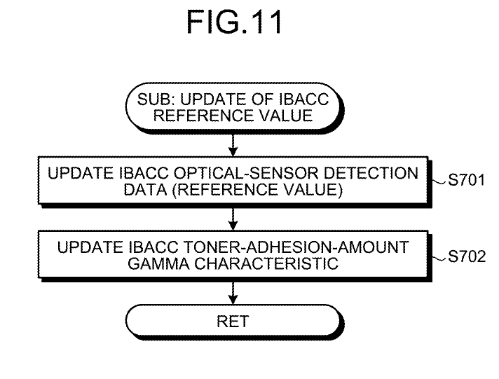

When data of the pattern part has been read properly, the main control unit 130 creates gradation conversion tables for each text area and each photograph area with respect to each of YMCK colors on the basis of read values of the ACC patterns (Step S608), and stores the created gradation conversion tables (Step S609). At this time, the main control unit 130 can store the read values of the ACC patterns acquired at Step S605. The main control unit 130 stores a read value of the last IBACC pattern as a new reference value (Step S610). Details of Step S610 will be described in FIG. 11. Furthermore, the number of times the execution of the ACC (auto color calibration) has been determined is measured at Step S505 in FIG. 5; however, this number is cleared to zero by the process at Step S610.

FIG. 8 is a diagram for explaining an IBACC pattern formed on an image carrier (an intermediate transfer belt). The optical sensor 136b detects the reflectivity of n IBACC patterns with different gradations formed on the intermediate transfer belt 109 as an image carrier, and sets the detected reflectivity as detected data (a reference value).

FIG. 9 is a diagram for explaining how to determine whether the execution of ACC is necessary or not at Step S504 in FIG. 5.

A graph (a) in a second phenomenon in FIG. 9 represents IBACC optical-sensor detection data (a reference value), where the horizontal axis indicates a detection output [V] from an IBACC optical sensor, and the vertical axis indicates a write value of an IBACC pattern. Detection data of the formed IBACC pattern detected at predetermined timing at the time of execution of ACC that the IBACC optical sensor has obtained is shown as an a1 detection result 1.

A graph (c) in a first phenomenon represents an IBACC toner-adhesion-amount gamma characteristic (a reference value), where the horizontal axis indicates a toner adhesion amount [mg/cm²] on an image carrier (such as a transfer belt or a photoconductor). An example of a relationship with a toner adhesion amount [mg/cm²] on the image carrier (the intermediate transfer belt 109) corresponding to the a1 detection result 1 is shown as a c1 toner-adhesion-amount gamma characteristic 1. A relationship between the a1 detection result 1 and the graph (c) is defined at the time of design.

In a graph of the a1 detection result 1, a1-1 denotes a range of high sensitivity to a toner adhesion amount, and a1-2 denotes a range of low sensitivity to a toner adhesion amount. In the range a1-2 of the graph, a toner adhesion amount varies, whereas a variation in (a) optical-sensor detection data is small, which means the range a1-2 is a range in which an exact toner adhesion amount cannot be acquired from a detection result from the optical sensor.

A graph (b) in a third phenomenon represents IBACC optical-sensor detection data (the latest value), where the vertical axis indicates a write value of a (latest) detected pattern. As an example of a detection result, a b1 detection result 2 and a b2 detection result 3 are shown. The b1 detection result 2 and the b2 detection result 3 differ from the a1 detection result 1 in detection timing. As described above, the a1 detection result 1 is a result of detection at the predetermined timing at the time of execution of ACC; the b1 detection result 2 and the b2 detection result 3 are results of detection after the elapse of a predetermined period of time since the execution of ACC or after the image development for a predetermined number of sheets since the execution of ACC or after a change in environment, such as temperature and humidity, since the execution of ACC. In the b1 detection result 2, b1-1 denotes a range of high sensitivity to a toner adhesion amount, and b1-2 denotes a range of low sensitivity to a toner adhesion amount. In the b2 detection result 3, b2-1 denotes a range of high sensitivity to a toner adhesion amount, and b2-2 denotes a range of low sensitivity to a toner adhesion amount.

A graph (d) in a fourth phenomenon represents IBACC toner-adhesion-amount gamma characteristic (the latest value). Toner adhesion amounts calculated from the b1 detection result 2 and the b2 detection result 3 are shown as a d1 toner-adhesion-amount gamma characteristic 2 and a d2 toner-adhesion-amount gamma characteristic 3, respectively. Here, an exact toner adhesion amount cannot be acquired from optical-sensor detection data of the regions b1-2 and b2-2, and therefore an inferred part of a d1-1 toner-adhesion-amount gamma characteristic 2 and an inferred part of a d2-1 toner-adhesion-amount gamma characteristic 3 are shown in dotted lines.

In the d1 toner-adhesion-amount gamma characteristic 2 calculated from the (high) sensitivity region b1-1 of the b1 detection result 2 by using the c1 toner-adhesion-amount gamma characteristic 1 and the a1 detection result 1, if an intermediate part of a d1-2 toner-adhesion-amount gamma characteristic 2 agrees with the c1 toner-adhesion-amount gamma characteristic 1 within a predetermined error range, the inferred part of the d1-1 toner-adhesion-amount gamma characteristic 2 can be presumed to agree with a toner adhesion amount of the c1 toner-adhesion-amount gamma characteristic 1.

On the other hand, the d2 toner-adhesion-amount gamma characteristic 3 corresponding to the low-sensitivity region b2-2 of the b2 detection result 3 can be presumed to be likely to be a characteristic as exemplified by the inferred part of the d2-1 toner-adhesion-amount gamma characteristic 3, and cannot be uniquely determined.

Subsequently, how to determine whether the execution of ACC is necessary or not is explained with a 4-dimensional chart consisting of the graph (c) in FIG. 9 as a third phenomenon, the graph (d) as a fourth phenomenon, a graph (e) as a first phenomenon, and a graph (f) as a second phenomenon.

The graph (e) exemplifies an e1 IBACC reference gamma characteristic 1 as an IBACC reference gamma characteristic with an image input signal on the horizontal axis. The graph (f) represents an IBACC correction gamma characteristic, and an f2 IBACC correction gamma characteristic 2 and an f3 IBACC correction gamma characteristic 3 are obtained in accordance with the d1 toner-adhesion-amount gamma characteristic 2 and the d2 toner-adhesion-amount gamma characteristic 3, respectively. With respect to the inferred part of the d1-1 toner-adhesion-amount gamma characteristic 2, an f1 IBACC correction gamma characteristic 1 that agrees with the e1 IBACC reference gamma characteristic 1 can be used.

On the other hand, as shown by an inferred part of an f3-1 IBACC correction gamma characteristic 3 in accordance with the inferred part of the d2-1 toner-adhesion-amount gamma characteristic 3, it cannot be uniquely determined. When a correction gamma characteristic as shown by the f3 IBACC correction gamma characteristic 3 has been acquired, the main control unit 130 determines that the execution of auto color calibration (ACC) is necessary, and informs a user of the execution of ACC, for example, through the operation screen shown in FIG. 10. As shown in FIG. 10, when the main control unit 130 has determined that the execution of ACC is necessary, for example, a message “It is recommended to execute auto color calibration through the default setting screen.” is displayed on the lower part of the operation screen.

In the graph (d), the inferred part of the d1-1 toner-adhesion-amount gamma characteristic 2 agrees with the c1 toner-adhesion-amount gamma characteristic 1, so that a g1 difference Δ(3−1) represents a difference in a write value of the IBACC pattern for achieving a predetermined toner adhesion amount [M/A1] between the c1 toner-adhesion-amount gamma characteristic 1 and the d2 toner-adhesion-amount gamma characteristic 3 or a difference in an image output signal with respect to an image input signal Nin1 in the graph (f). Namely, in the graph (d), Δ(3−1)=(an IBACC-pattern write value in the toner-adhesion-amount gamma characteristic 1 for achieving the IBACC toner adhesion amount [M/A1])−(an IBACC-pattern write value in the toner-adhesion-amount gamma characteristic 3 for achieving the IBACC toner adhesion amount [M/A1])=WL3([M/A1])−WL1([M/A1]) is calculated, and, if the difference Δ(3−1) exceeds a predetermined value ΔTh, i.e., if Δ(3−1)>ΔTh is satisfied, the main control unit 130 determines that the execution of ACC (auto color calibration) is necessary.

Furthermore, Δ(3−1)=(an image output signal Nout in the IBACC correction gamma characteristic 3 for achieving the image input signal Nin1)−(an image output signal Nout in the IBACC correction gamma characteristic 1 for achieving the image input signal Nin1)=Nout3(Nin1)−Nout1(Nin1) is calculated, and, if the difference Δ(3−1) exceeds a predetermined value ΔTh, i.e., if Δ(3−1)>ΔTh is satisfied, the main control unit 130 determines that the execution of ACC (auto color calibration) is necessary.

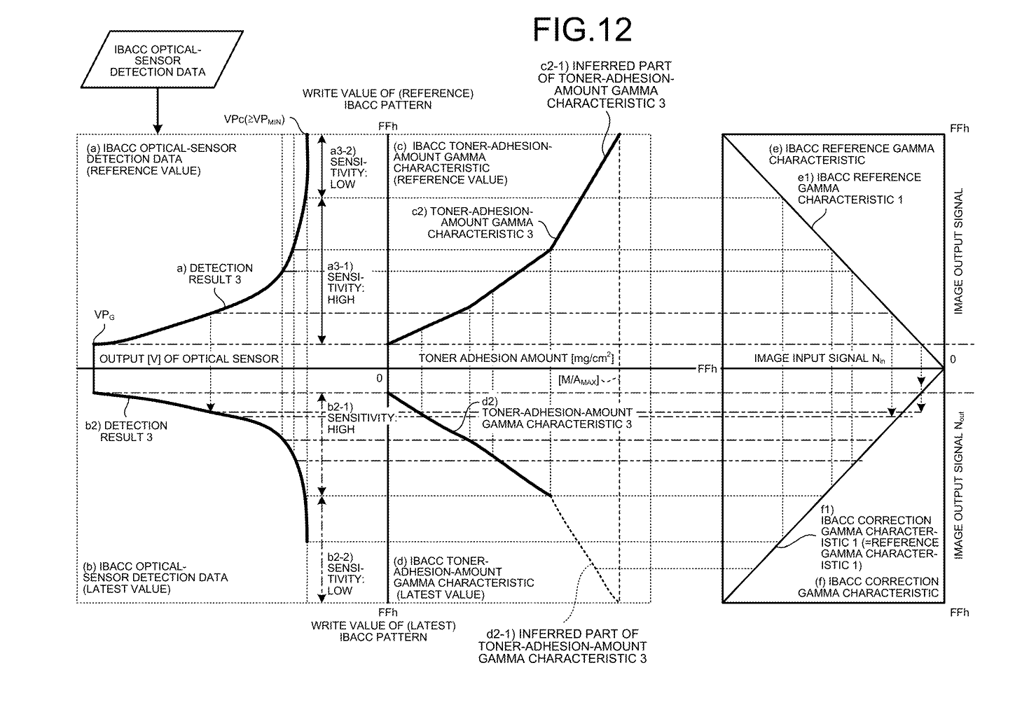

When the b2 detection result 3 shown by the graph (b) in FIG. 9 has been obtained, and ACC (auto color calibration) has been executed, a process of updating the IBACC reference value is performed by the main control unit 130. This IBACC-reference-value updating process is explained with a flowchart shown in FIG. 11 and FIG. 12.

At Step S701 in FIG. 11, the b2 detection result 3 is used as a new reference value a2 detection result 3 of optical-sensor detection data (a reference value) shown by the graph (a). At Step S702, the d2 toner-adhesion-amount gamma characteristic 3 is updated with a new reference value c2 toner-adhesion-amount gamma characteristic 3 of a (c) toner-adhesion-amount gamma characteristic.

In FIG. 12, contents of graphs (a) to (f) are the same as shown in FIG. 9. At Step S702 in FIG. 11, tones corresponding to IBACC-pattern write values in the low-sensitivity region b2-2 are adjusted to predetermined tones by the execution of ACC (auto color calibration), the inferred part of the d2-1 toner-adhesion-amount gamma characteristic 3 is arbitrarily determined by linear function interpolation or spline interpolation, etc. between the (high) sensitivity region b2-1 of the d2 toner-adhesion-amount gamma characteristic 3 and the control maximum adhesion amount [M/Amax] included in image forming conditions.

The present invention can be achieved in such a way that a storage medium storing therein a program code of software for realizing the functions described in the above embodiment is supplied to a system or apparatus, and a computer (a CPU or an MPU) of the system or apparatus reads out and executes the program code stored in the storage medium. In this case, the program code read out from the storage medium realizes the functions described in the above embodiment. The storage medium used to supply the program code includes, for example, a hard disk, an optical disk, a magnet-optical disk, a non-volatile memory card, and a ROM, etc. Furthermore, by executing the program code read by the computer, the functions described in the above embodiment are realized, which includes the case where an operating system (OS) or the like running on the computer performs all or part of actual processes according to instructions of the program code and the functions described in the above embodiment are realized by the processes. Moreover, the functions described in the above embodiment can be realized in such a way that after the program code read out from the storage medium is written on a feature expansion board inserted into the computer or a memory included in a feature expansion unit connected to the computer, a CPU or the like included in the feature expansion board or feature expansion unit performs all or part of actual processes according to instructions of the program code and the functions described in the above embodiment are realized by the processes. Furthermore, a program for realizing the functions described in the embodiment of the present invention can be provided from a server through communication via a network.

According to the present invention, appropriate timing to execute auto color calibration (ACC) using a scanner can be obtained from read values of a gradation pattern (an IBACC pattern) formed on an image carrier (an intermediate transfer belt).

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a first correcting unit that reads a gradation pattern output onto a predetermined medium and corrects a gradation conversion information;
a second correcting unit that reads a gradation pattern formed on an image carrier included in the image forming apparatus and corrects a gradation conversion information;
a detecting unit that detects a gradation characteristic of the gradation pattern formed on the image carrier at the time of execution of correction by the second correcting unit; and
a determining unit that determines whether to execute correction by the first correcting unit on the basis of the detected gradation characteristic.

2. The image forming apparatus according to claim 1, wherein
the determining unit informs a user of an instruction to execute the correction by the first correcting unit when the number of determinations to execute the correction by the first correcting unit has reached a predetermined number.

3. The image forming apparatus according to claim 1, wherein
the detecting unit detects an adhesion amount of color material adhered onto the image carrier, and
the determining unit determines whether to execute the correction by the first correcting unit on the basis of an amount of change in the adhesion amount of the color material.

4. An image forming method performed by an image forming apparatus, the method comprising:
a first correcting step of reading a gradation pattern output onto a predetermined medium and correcting a gradation conversion information;
a second correcting step of reading a gradation pattern formed on an image carrier included in an image forming apparatus and correcting a gradation conversion information;
a detecting step of detecting a gradation characteristic of the gradation pattern formed on the image carrier at the time of execution of the second correcting step; and
a determining step of determining whether to execute the first correcting step on the basis of the detected gradation characteristic.

5. A computer program product according to claim 4, the product comprising a non-transitory computer-readable recording medium having computer readable program codes, performed by the image forming apparatus, the program codes when executed causing the image forming apparatus to execute the method of claim 4.

6. A non-transitory computer-readable recording medium according to claim 4, the medium having computer readable program codes, performed by the image forming apparatus, the program codes when executed causing the image forming apparatus to execute the method of claim 4.
